(19) United States
(12) Patent Application Publication
(10) Pub. No.: US 2013/0063726 A1
(43) Pub. Date: Mar. 14, 2013

(54) SENSOR AND A METHOD FOR CHARACTERISING A DIELECTRIC MATERIAL

(71) Applicants: Tanya Mary Monro, South Australia (AU); Alexandre Guy Michel Francois, South Australia (AU); Jonathan Boehm, South Australia (AU)

(72) Inventors: Tanya Mary Monro, South Australia (AU); Alexandre Guy Michel Francois, South Australia (AU); Jonathan Boehm, South Australia (AU)

(73) Assignee: ADELAIDE RESEARCH & INNOVATION PTY LTD.

(21) Appl. No.: 13/635,276

(22) PCT Filed: Mar. 11, 2011
(86) PCT No.: PCT/AU2011/000275

§ 371 Date: Nov. 21, 2012

(30) Foreign Application Priority Data
Mar. 17, 2010 (AU) 2010901110
Jan. 14, 2011 (AU) 2011900130

(51) Int. Cl. G01N 21/55

(52) U.S. Cl. 356/445

(57) ABSTRACT

The present disclosure provides a method of characterising a dielectric material. The method comprises the step of providing a light source, a light collector and a sensor. The sensor is arranged so that an evanescent field of light penetrates through a surface of the sensor and surface plasmons are generated at the surface of the sensor when suitable light is directed along at least a portion of the sensor. The method also includes the step of exposing the surface of the sensor to the dielectric material so that an interface is formed between the surface and the dielectric material. Further, the method comprises guiding light along at least a portion of the sensor to generate the surface plasmons. In addition, the method comprises the step of collecting an intensity of light from the interface as a function of a spectral parameter of the light. Further, the present disclosure provides an apparatus for characterising the dielectric material in accordance with the method.

### FIELD OF THE INVENTION

The present invention broadly relates to a sensor and a method for characterising a dielectric material and relates particularly, though not exclusively, to an evanescent field sensor and a method of characterising the dielectric material using the evanescent waves.

### BACKGROUND OF THE INVENTION

Surface plasmons are coherent oscillations of electrons along an interface between two materials at which the real part of the dielectric function changes sign. The energy of the surface plasmons depends on properties of the materials. Consequently, the detection of surface plasmons can be used to detect the materials.

In the past optical sensors have been proposed and typically comprise a prism having a thin metal coating, such as a thin silver or gold coating on a surface. The thin metal coating is in contact with an external sample dielectric material, such as a biological suspension. The surface plasmons at the interface between the coating and the sample dielectric material can be excited when the propagation constant of the incident light is equal to the propagation constant of the surface plasmon, and the wavelength at which this occurs depends on the refractive index of the sample dielectric material and the wavelength of the light. The generation of surface plasmons resonances results in spectral minimum of transmitted or reflected light intensity at the metal/dielectric interface. Consequently, it is possible to characterise the sample dielectric material by characterising a property of the transmitted light.

More recent optical sensors comprise optical waveguides that replace the prism and the metallic coating is applied onto the optical waveguide.

However, the detection limit of existing waveguide-based method is unsatisfactory for some applications. There is a need for technological advancement.

### SUMMARY OF THE INVENTION

The present invention provides in a first aspect a method of characterising a dielectric material, the method comprising the steps of:
providing a light source, a light collector and a sensor, the sensor being arranged so that an evanescent field of light penetrates through a surface of the sensor and surface plasmons are generated at the surface of the sensor when suitable light is directed along at least a portion of the sensor;
exposing the surface of the sensor to the dielectric material so that an interface is formed between the surface and the dielectric material;
guiding light along at least a portion of the sensor to generate the surface plasmons; and
collecting an intensity of light from the interface as a function of a spectral parameter of the light.

Throughout this specification the term “dielectric material” is used for any type of material that has dielectric properties and including for example suitable gaseous, solid, liquid materials. In one example the dielectric material is a solution or suspension of a material, such as a biological material.

The sensor typically comprises an optical waveguide, such as an optical fibre or any other suitable type of optical waveguide. A film formed from a material suitable for generation of surface plasmons may be positioned at a surface of the optical waveguide. The surface of the sensor may be a surface of the film and the film may be arranged such that the evanescent field of light guided through the optical waveguide penetrates through the surface of the film.

The step of collecting an intensity of light from the interface typically comprises collecting light that penetrates through at least a portion of the dielectric material.

Embodiments of the present invention have significant practical advantages. A dependency of a limit of detection on the thickness of the film typically is reduced compared with conventional transmission methods. Further, a detection limit that is achievable with the above-defined method may be improved compared with conventional waveguide based transmission methods.

The spectral parameter of the light typically is a wavelength of the light, but may alternatively also be a frequency or an energy of the light or any other parameter that is either directly or indirectly related to the wavelength.

In one example the apparatus comprises a first and a second optical waveguide and the step of guiding light along at least a portion of the sensor comprises guiding light through the first waveguide. In this case the step of collecting an intensity of light from the interface may comprise coupling the intensity of light from the interface into the second waveguide. A film formed from a material suitable for generation of surface plasmons may be positioned at a surface of the first optical waveguide. Alternatively, a film formed from a material suitable for generation of surface plasmons may be positioned at a surface of the second optical waveguide.

The step of guiding light along at least a portion of the sensor may comprise absorbing light from the light source and emitting suitable fluorescence light to generate the surface plasmons.

In one example the method comprises collecting an intensity of light from at least one interface with at least one sample dielectric material and from at least one interface with at least one reference dielectric material. Alternatively, the method may for example comprise collecting an intensity of light only from an interface with a sample dielectric material.

The sensor may be one of at least two sensors and the method may comprise exposing at least one sensor to the sample dielectric material and at least one sensor to a reference dielectric material. In this case the method typically comprises collecting light from interfaces at the at least two sensors using respective collector elements of the collector. In one specific embodiment the at least two sensors comprise respective portions of an optical waveguide and are positioned in sequence along that optical waveguide.

In a specific example the sample dielectric material contains a solute, such as a biological solute, in a solvent and the reference dielectric material comprises the solvent only. Alternatively, the dielectric material may for example be provided in the form of a suspension, such as a suspension of a virus or any other suitable biological sample, and the reference dielectric material may comprise only the liquid that suspends the biological sample.

The step of exposing the surface of the sensor to the dielectric material may also comprise functionalising the surface and thereby providing a surface specificity such that predominantly a predetermined biological species, such as a virus, adsorbs at the surface when the surface is exposed to a suitable dielectric material. In this case the step of collecting an intensity of light from the interface may comprise detecting a change of a property of the light as a function of adsorbed dielectric material and thereby characterising the dielectric material.

Alternatively, the step of exposing the surface of the sensor to the dielectric material may also comprise coating the surface with a coating material that is selected so that the dielectric material, for example a suitable chemical such as molecule that is capable of selectively cleaving spacer molecules (for example an enzyme), will remove molecules of the coating material from the surface when the surface is exposed to the dielectric material. In this case the step of collecting an intensity of light from the interface may comprise detecting a change of a property of the light as a function of removal of coating material and thereby indirectly characterising the dielectric material.

The step of collecting an intensity of light typically comprises generating electronic data and the method typically also comprises the step of processing the electronic data, which may for example comprise comparing collected light intensities for the sample dielectric material with those for the reference dielectric material.

In one specific embodiment the step of processing the electronic data comprises identifying a spectral maximum of the light intensity data for the sample dielectric material compared with light intensity data for the dielectric reference material.

The present invention provides in a second aspect an apparatus for characterising a dielectric material, the apparatus comprising:
at least one sensor having a sensing region and an optical waveguide for guiding light through or adjacent the sensing region, the sensing region comprising a film having a structured surface for forming an interface with the dielectric material, the sensor being arranged such that the evanescent field of the light penetrates through at least a portion of the interface when suitable light is directed along the sensing region;
a light source; and
at least one collector for collecting an intensity of light from the interface as a function a spectral parameter of the light.

The structured surface of the film typically is structured so that the surface has a roughness, but may also have a corrugation, such as a corrugation on a micro-scale, or may be otherwise structured in a regular or irregular manner.

The spectral parameter of the light typically is a wavelength of the light, but may alternatively also be a frequency or an energy of the light or any other parameter that is either directly or indirectly related to the wavelength.

In one example the light source is arranged for emitting light having a continuous wavelength range, such as a suitable “white” light source. In this case the collector typically comprises a spectrometer for detecting the intensity of the light from the at least one interface as a function of the spectral parameter. Alternatively, the light source may be a tunable light source or may comprise one or more monochromatic light sources.

The apparatus may comprise any suitable type of optical waveguide, such as an optical fibre.

In one specific example a sample dielectric material contains a biological solute in a solvent and a reference dielectric material comprises the solvent only.

Alternatively, the dielectric material may be provided in the form of a suspension of a biological sample, such as a suspension of a virus, and the reference dielectric material may comprise only the liquid that suspends the biological sample or a reference biological suspension.

In one specific embodiment the sensor is one of at least two sensors and the collector comprises at least two collector elements for collecting light from respective sensors. For example, the at least two sensors may each comprise respective regions of the optical waveguide and may be positioned in succession along that optical waveguide. At least one sensor may be arranged for contact with a sample dielectric material and at least one sensor may be arranged for contact with a reference material. In this case the apparatus has the significant practical advantage that sample and reference measurements can be performed substantially in parallel and light originating from the interfaces may also be multiplexed. For example, an effect of a change in temperature or other environmental fluctuation on a measurement result typically can be corrected in a relatively simple manner or even neglected if the first and the second sensing regions experience the same or a similar change in temperature.

In one embodiment the apparatus comprises a fluorescent material for absorption of light from the light source and emission of fluorescence radiation. The fluorescent material typically is arranged such that at least a portion of emitted fluorescence light is used for generation of surface plasmons. The film may be positioned over the fluorescent material. Alternatively or additionally the fluorescent material may be positioned within the optical waveguide or in any other suitable area on the waveguide.

The fluorescent material typically is selected to supplement a light intensity and/or a wavelength range of the light source.

In one specific embodiment the apparatus comprises a first optical waveguide for guiding the light from the light source and a second optical waveguide into which in use light from the interface is coupled. The film formed from a material suitable for generation of surface plasmons typically is positioned at a surface of the first optical waveguide.

In one example the apparatus comprises an array of sensors and is arranged so that a distribution of a property of the dielectric material can be detected. The apparatus may comprise an array of m×n sensors and m first optical waveguides and n second optical waveguides, each first optical waveguide having n sensing regions and each second optical waveguide being arranged to receive light form m interfaces, wherein the apparatus is arranged so that a distribution of a property of the dielectric material can be detected.

The film typically comprises Ag, Au, Al or Cu or any other material that is suitable for generation of surface plasmons. The film typically has a thickness within the range of 20-150 nm, such as approximately 50 nm. The film may be fabricated using any suitable deposition technique that results in a film having a surface roughness, such as a film having a granular structure. Suitable film deposition techniques include chemical and physical vapour deposition techniques or using suitable chemical reactions, such as a Tollens reaction or suitable chemical or physical adsorption of metallic nanoparticles.

The present invention provides in a third aspect method of characterising a dielectric material, the method comprising the steps of:
generating surface plasmons by an evanescent field of light that penetrates an interface formed between a surface of a sensor and the dielectric material;
collecting a first intensity of light as a function of a spectral parameter of the light, the first intensity of light being indicative of an intensity of the generated surface plasmons; and
collecting a second intensity of light as a function of a spectral parameter of the light, the second intensity of light being indicative of a property of the dielectric material.

The second intensity of light may be associated with light emitted by label molecules.

The steps of collecting the first and second intensities of light typically comprise collecting the first and second intensities of light from the interface. The first and second intensities of light may be collected sequentially or simultaneously.

The property of the dielectric material typically is indicative of an immobilisation of a biological species at the interface and the label molecules typically emitting fluorescence radiation having a spectral distribution that is also indicative of immobilisation of the specific biological species with the label molecules at the interface.

In one specific example the label molecules are Qdots. The dielectric material may comprise a biological suspension and the method may comprise functionalising the surface at the interface thereby providing a surface specificity such that predominantly a predetermined biological species adsorbs and the label molecules adsorb at the biological species whereby both the first and second light intensities are independently indicative of immobilisation of the biological species at the interface.

The method may also comprise exposing the surface to spacer molecules that are arranged for adsorption at the surface of the interface and are also arranged for coupling to label molecules, such as fluorescent labels that may also locally increase the refractive at the surface. In this case the method typically comprises adsorption of the spacer molecules on a surface of the interface and coupling of the label molecules to the spacer molecules.

Throughout this specification the term “spacer molecules” is used for any type of molecules that is suitable for adsorption at the surface of the interface, coupling to the label molecules and are arranged for cleaving by a predetermined type of molecule.

In one specific embodiment the spacer molecules are arranged for cleaving by a chemical or a biological species of the dielectric material (for example an enzyme). In this case the method typically comprises detecting a spectrally dependent change in the intensity, which is indicative of cleaving of the spacer molecules and adsorption of the chemical or a biological species at the cleaved spacer molecule on the surface of the interface. Alternatively, the method may comprise detecting a correlated spectral change in the first and second intensities, which is indicative of cleaving of the spacer molecules and adsorption of the chemical or biological species at the cleaved spacer molecule on the surface of the interface.

The method may also comprise the step of re-attaching cleaved portions to respective cleaved spacer molecules at the interface such that the spacer molecules are again arranged for coupling to the label molecules.

The method in accordance with the third aspect of the present invention typically comprises the method in accordance with the first aspect of the present invention.

Alternatively or additionally, the second intensity of light may relate to second harmonic generation (SHG) associated with a surface plasmon excitation at the interface. In this case the method typically comprises directing suitable light to the interface, the suitable light having a wavelength in the range of a fundamental resonance wavelength of the plasmonic excitation. The method typically comprises the step of analysing the second intensity to obtain information concerning an orientation or change thereof and/or a comformation or change thereof of biological species at the interface.

The present invention provides in a fourth aspect an apparatus for characterising a dielectric material, the apparatus comprising:
at least one sensor having a sensing region and being arranged for directing suitable light though or adjacent the sensing region, the sensing region having a surface for forming an interface with the dielectric material, the sensor being arranged such that an evanescent field of the light penetrates through at least a portion of the interface whereby surface plasmons are generated at that interface;
a light source; and
at least one collector for collecting first and second intensities of light as a function of a spectral parameter of the light, the first light intensity being indicative of an intensity of the generated surface plasmons and the second light intensity being associated with label a property or of the dielectric material.

The second light intensity may include an intensity of fluorescence light and the label molecules may comprise Qdots that emit the fluorescence light having a spectral distribution that is indicative of immobilisation of the label molecules at the interface.

The apparatus typically comprises the apparatus in accordance with the second aspect of the present invention.

The apparatus according to the fourth aspect of the present invention has significant practical advantages. The apparatus enables (for the first time) performing surface plasmon resonance studies together with another sensing techniques, such as fluorescence spectroscopy, using the same apparatus. Consequently, the apparatus combines key advantages of both sensing techniques within a single platform, which is not possible using existing platforms. Further, it is possible to provide independent confirmation of a diagnostic using the other sensing technique, which also increases the detection specificity. The invention will be more fully understood from the following description of specific embodiments of the invention. The description is provided with reference to the accompanying drawings.

### BRIEF DESCRIPTION OF THE DRAWINGS

FIG. 1 is a flow diagram illustrating a method of characterising a dielectric material in accordance with an embodiment of the present invention;

FIG. 2 is a schematic diagram of an apparatus for characterising a dielectric material in accordance with an embodiment of the present invention;

FIG. 3 is a schematic diagram of an apparatus for characterising a dielectric material in accordance with a further embodiment of the present invention;

FIGS. 4 (a) and (b) are schematic diagrams of apparatus for characterising a dielectric material in accordance with embodiments of the present invention;

FIG. 5 is a schematic diagram of an apparatus for characterising a dielectric material in accordance with an embodiment of the present invention;

FIGS. 6(a) and (b) are graphs showing spectral characteristics of light transmitted through a sensor and light emitted from a side portion of the sensor, respectively, using the apparatus of FIG. 2;

FIG. 7 is a graph showing a numerical simulation of surface plasmon resonance produced by a 60 nm thick silver coating deposited on a 4 mm long section of a 140 mm diameter F2 fibre with a polymer cladding (n=1.52) when immersed in different refractive index liquids;

FIGS. 8(a) and (b) are graphs showing spectral characteristics of light transmitted through a sensor and light emitted from a side portion of the sensor, respectively, using the apparatus of FIG. 2, the apparatus having a silver film thickness of 21 nm, the measurements being taken for liquids having different refractive indices;

FIGS. 9(a) and (b) are graphs showing spectral characteristics of light transmitted through a sensor and light emitted from a side portion of the sensor, respectively, using the apparatus of FIG. 2, the apparatus having a silver film thickness of 40 nm, the measurements being taken for liquids having different refractive indices;

FIGS. 10(a) and (b) are graphs showing spectral characteristics of light transmitted through a sensor and light emitted from a side portion of the sensor, respectively, using the apparatus of FIG. 2, the apparatus having a silver film thickness of 55 nm, the measurements being taken for liquids having different refractive indices;

FIGS. 11(a) and (b) are graphs showing spectral characteristics of light transmitted through a sensor and light emitted from a side portion of the sensor, respectively, using the apparatus of FIG. 2, the apparatus having a silver film thickness of 65 nm, the measurements being taken for liquids having different refractive indices;

FIGS. 12(a) and (b) are graphs showing spectral characteristics of light transmitted through a sensor and light emitted from a side portion of the sensor, respectively, using the apparatus of FIG. 2, the apparatus having a silver film thickness of 82 nm, the measurements being taken for liquids having different refractive indices;

FIGS. 13(a) and (b) are graphs showing spectral characteristics of light transmitted through a sensor and light emitted from a side portion of the sensor, respectively, using the apparatus of FIG. 2, the apparatus having a silver film thickness of 132 nm, the measurements being taken for liquids having different refractive indices;

FIG. 14 is a graph of a spectral position of surface plasmon resonances as a function of coating thickness;

FIG. 15 is a graph of signal to noise ratios of surface plasmon resonances obtained using the apparatus of FIG. 2;

FIGS. 16(a) and (b) are graphs of spectral characteristics of liquids having different refractive indices, the data having been obtained using the apparatus of FIG. 3, the first sensor of the apparatus of FIG. 3 having been used for reference measurements and the second sensor of the apparatus of FIG. 3 having been used for sample measurements;

FIGS. 17(a) and (b) are graphs of spectral characteristics of liquids having different refractive indices, the data having been obtained using the apparatus of FIG. 3, the second sensor of the apparatus of FIG. 3 having been used for reference measurements and the first sensor of the apparatus of FIG. 3 having been used for sample measurements;

FIG. 18 illustrates an apparatus in accordance with a specific embodiment of the present invention;

FIG. 19 illustrates an application in accordance with a specific embodiment of the present invention;

FIG. 20 shows measurement results associated with the application illustrated in FIG. 19;

FIG. 21 shows measurement results associated with the application illustrated in FIG. 20;

FIG. 22 illustrates an application in accordance with a specific embodiment of the present invention; and

FIG. 23 illustrates Surface Plasmon resonance positions at different stage of the surface coating.

### DETAILED DESCRIPTION OF SPECIFIC EMBODIMENTS

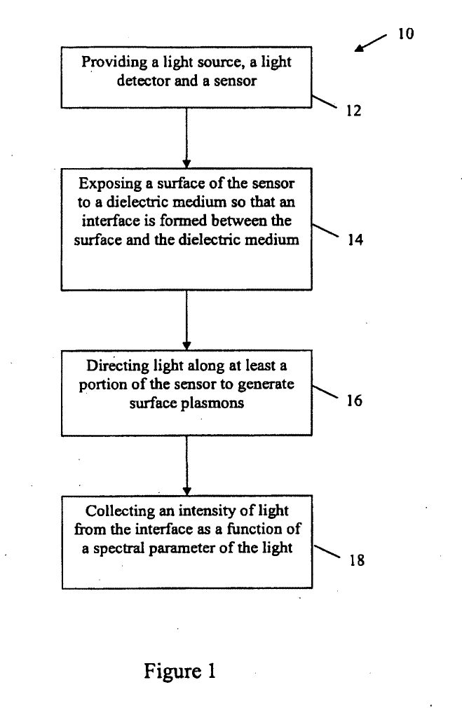

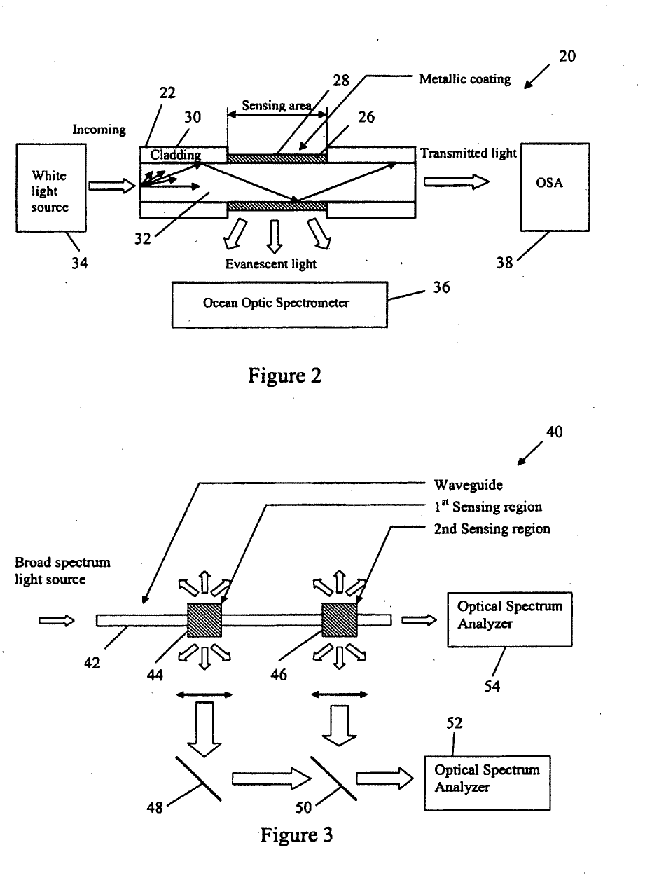

Referring initially to FIG. 1 and FIG. 2, a method and apparatus for characterising a sample dielectric material are described. In the examples that follow, the sample dielectric material contains a biological sample and characterising the dielectric material comprises obtaining spectral information in respect of the sample dielectric material so as to charaterise the biological sample.

In the embodiment described in FIG. 1, the method 10 comprises a first step 12 of providing a light source, a light collector and a sensor. Such a light source 34, collector 36 and sensor 22 are shown in FIG. 2 and form an apparatus 20 for use in characterising a dielectric material.

The sensor 22 comprises a waveguide that is in this example provided in the form of an optical fibre comprising a core region 32 and a thin film 26 on the core region 32. The thin film 26 is formed from a material suitable for the generation of surface plasmons and has a surface 28. It is to be appreciated that in alternative embodiments the film 26 may not be deposited directly on the core region, but may be deposited on the thin cladding region.

Further, the film 26 is arranged such that the evanescent field of suitable light such as light produced by the light source 34 guided through the core region 32 penetrates through the surface 28 of the film 26. In this example the film 26 comprises Ag. However it will be appreciated that the film 26 may alternatively comprise Au, Al, Cu or any other material that is suitable for generation of surface plasmons.

To allow the evanescent field of light guided through the core region 32 to penetrate through the surface 28 of the film 26, the film 26 has a thickness within the range of 20-150 nm, such as approximately 50 nm.

In a second step 14 of the method 10, a surface 28 of the sensor 22 is exposed to the sample dielectric material so as to form an interface between the exterior surface 28 of the film 26 and the sample dielectric material.

In a third step 16 of the method 10, light is directed through the sensor 22 so as to generate surface plasmons at the exterior surface 28 of the film 26. An intensity of light the surface 28 is then collected as a function of a wavelength of the light in a fourth step 18.

The method 10 and the apparatus 20 provide the advantage of reducing the dependency of a limit of detection on the thickness of the film compared with conventional methods that detect a sample dielectric material by analysing transmitted light.

Although the above example describes the sensor 22 as comprising a waveguide, it will be appreciated that the sensor 22 may be of any appropriate form.

As mentioned earlier, the film 26 of sensor 22 comprises Ag. Ag is an appropriate material to be used to assist in generating surface plasmons. For example, Ag can be deposited using a chemical reaction based on the reduction of silver nitrate with glucose. A person skilled in the art will appreciate that alternatively suitable physical or chemical vapour depositions techniques may be used. Further, suitable chemical or physical adsorption of metallic nanoparticles may be used to form the Ag film. Now described is a specific example of a sensor 22 and a method of fabricating the sensor 22. The sensor 22 comprises an optical fibre comprising F2 glass (Schott) with a refractive index of 1.62 and having a core diameter of 140 μm. The optical fibre has a polymer cladding having a refractive index of 1.52 (NA=0.56). A small section of the optical fibre, about 4 mm long, is stripped of the cladding and subsequently chemically coated with silver using the so-called “Tollens” reaction.

The Tollens reaction, also known as the silver mirror reaction, comprises adding a solution of silver ammonia to a reducing agent, usually a sugar such as glucose, in order to produce silver nanoparticles that may subsequently be attached to a substrate. The preparation of the Tollens reagents starts with the oxidation of a silver nitrate solution (20 mL of 0.24 mol/L AgNO3) into silver oxide using potassium hydroxide (40 uL of 0.25 mol/L KOH) according to Equation 1 below. This produces a brown precipitate in the initially transparent silver nitrate solution. Ammonia (3 mol/L) is then added drop by drop to dissolve the silver oxide and produce a transparent silver ammonia complex according to Equation 2.

2AgNO₃+2KOH→Ag₂O(s)+2KNO₃+H₂O (1)

Ag₂O(s)+4NH₃+2KNO₃+H₂O(l)→2Ag(NH₃)₂NO₃+2KOH (2)

A reducing agent comprising a mixture of methanol and glucose (1.9 mol/L) solution is made in the ratio of 1:2 and added in equal parts to the silver ammonia solution, then mixed using a magnetic stirrer. Once the reducing agent is added to the silver ammonia solution, the reaction produces a metallic silver coating according to Equation 3.

CH₂OH(CHOH)₄CHO+2Ag(NH₃)₂+3OH⁻→2Ag(s)+CH₂OH(CHOH)₄CO₂⁻+4NH₃+2H₂O (3)

A stripped section of the optical fibre is then placed, at room temperature, into a beaker containing the silver coating solution and left inside the beaker for an appropriate period of time as to form a film of Ag of appropriate thickness. After coating, the optical fibre is rinsed in de-ionized water and then air dried. The thickness of the deposited silver coating may be measured by scanning electron microscopy, transmission electron microscopy or any other suitable method.

The method further comprises the step of detecting a reference dielectric material so that data of the sample dielectric material can be compared with data of the reference dielectric material, such as by subtracting the reference data from the sample data. This may include measuring the sample and reference dielectric media separately with the sensor 22.

Alternatively, the method may comprise exposing a first sensor to the reference dielectric and a second sensor to the sample dielectric. This may be achieved using an apparatus 50 as shown in FIG. 3, which comprises first and second sensors 44, 46 positioned in succession along the optical fibre 42.

The sample dielectric material may contain a biological suspension and the reference dielectric material may for example contain only the solution that suspends a biological sample. In this case the method comprises functionalising the surface such that predominantly a predetermined biological species, such as a virus, specifically interacts with the surface at the surface when the surface is exposed to a suitable dielectric material.

Alternatively, the dielectric material may for example be chemical such as an acid, having molecules with a relatively small molecular weight. In this case the method comprises coating the surface with a coating material that is selected so that the chemical will remove molecules or particles such as microspheres of the coating material from the surface when the surface is exposed to the chemical.

The method comprises exposing the surface of the first sensor 44 to a sample dielectric material and collecting an intensity of light from the surface of the first sensor 44 and exposing the surface of the second sensor 46 to a reference dielectric material and collecting an intensity of light from the surface of the second sensor 46.

Light from the surfaces of the first and second sensors 44, 46 is collected using respective collector elements of a collector (not shown) or by directing the light 44, 46 to a single collector 52 via respective reflective devices 48, 50.

The step of collecting an intensity of light comprises generating electronic data and the method also comprises comparing collected light intensities for the sample dielectric material with those for the reference dielectric material. Processing the electronic data comprises identifying a spectral maximum of the light intensity data for the sample dielectric material compared with light intensity data for the dielectric reference material.

In this example, the light source 34, a “supercontinuum” white light source, is used as a broad band light source and is coupled to the fibre samples using an achromatic lens. An output signal of light transmitted through the sensor 22, referred to as ‘transmission measurements’ in the following, is recorded using a transmitted light collector 38 such as an optical spectrum analyzer, and light from a surface of the film, referred to as ‘evanescent field measurements’ in the following, is collected using a collector 36. In this example the collector 36 comprises an optical fibre bundle and is analysed using a spectrometer.

Apparatus 20 and 40 shown in FIGS. 2 and 3, respectively, comprise broadband light sources. In a variation of these embodiments the light emitted by the light sources may be supplemented by fluorescence light. For example, a coating comprising suitable fluorescent dye molecules may be located between the metallic coating 28 and the waveguide 32. In this case the fluorescent material is selected such that at least a portion of light that is scattered (or otherwise directed) out of the waveguide 32 in the proximity of the metallic coating 28 is absorbed by the fluorescent material. The fluorescent material in turn emits light having a longer wavelength and is selected such that the emitted light has a wavelength that is suitable for generation of plasmon resonances. Such supplementing of light is particularly advantageous if a number of sensors are positioned in series along a waveguide. As at each sensor the transmitted light intensity is reduced, the light intensity at a last sensor may normally be insufficient, but can be supplemented in the above-described manner. Additionally of alternatively the fluorescent material may for example also be positioned within the waveguide material.

In one alternative example the apparatus does not comprise a broadband light source, but comprises instead a single monochromatic light source or a combination of multiple suitable monochromatic light sources. The fluorescent material comprises in this example different types of fluorescent dye molecules that are selected so that together they provide fluorescence light that has a sufficiently broad wavelength range.

In an alternative embodiment a further waveguide may be positioned in the proximity of the evanescent field of the waveguides 32 and 42 so that emitted light may be coupled into the further waveguide. A variation of such an embodiment is illustrated in Figure (a) and (b)

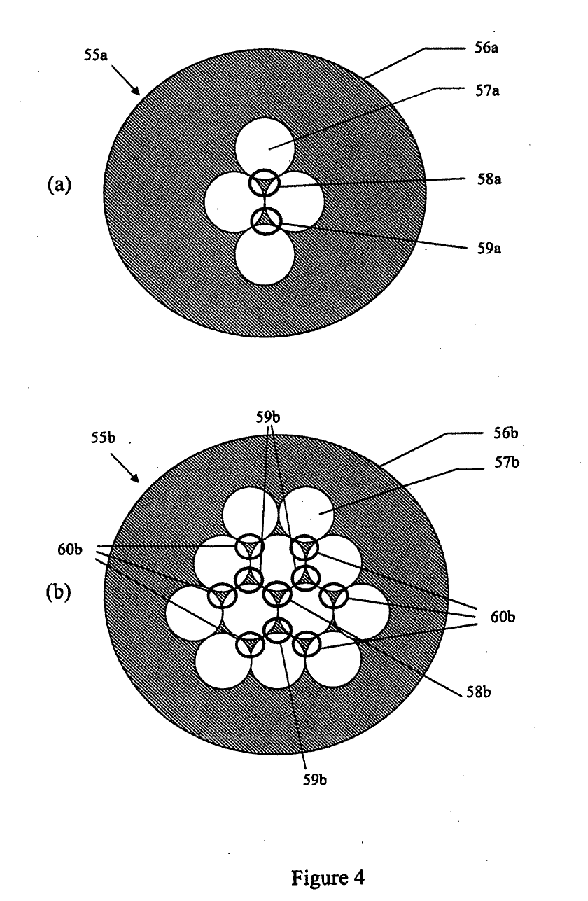

FIG. 4 (a) shows a cross-sectional representation of an apparatus 55a for characterising a dielectric material. The apparatus 55a comprises an optical fibre 56a having longitudinal tubular portions 57a in a cladding region and that are arranged such that core regions 58a and 59a are formed (indicated by circles in FIG. 4 (a)). The tubular portions 57a are in use at least partially filled with a dielectric material, such as a biological suspension or any other suitable dielectric material. The core regions 58a and 59a are either positioned in such a way that light can be coupled form one core region into the other or other methods, such as couplers or gratings, can be employed to couple right from one core to another. In the example illustrated in FIG. 4 (a) the core region 58a is partially coated with a thin Ag film so that an interface is formed between the Ag film and the dielectric material and plasmon resonances are generated at the interface when suitable light is directed through the core region 58a. The Ag film at the core region 58a is formed by coating the interior region of the upper tubular portion (as shown in FIG. 4(a)) with the Ag film. For example, the core region 59a may be is used to provide the light (broadband for example) which is subsequently coupled into the core region 58a and an evanescent field of light may for example be collected outside the optical fibre 56a at a side portion.

FIG. 4 (b) shows a cross-sectional representation of an apparatus 55b in accordance to a further variation. The 55b comprises an optical fibre 56b having longitudinal tubular portions 57b in a cladding region and that are arranged such that core regions 58b and 59b and 60b are formed (indicated by circles in FIG. 4 (b)). The core regions 58b and 59b are positioned such that light can be coupled between adjacent core regions with a relatively high efficiency whereas the core region 60b is slightly removed so that coupling of light from the core region 59b is largely avoided. For example, light may be guided by a core region 58b and a portion of the core region 59b may be coated with an Ag film. The core region 60b may be positioned for collection of the evanescent field from the Ag coated core region 59b.

A person skilled in the art will appreciate that FIGS. 4(a) and (b) show only examples of many different geometrical arrangements that are possible and are within the scope of embodiments of the present invention.

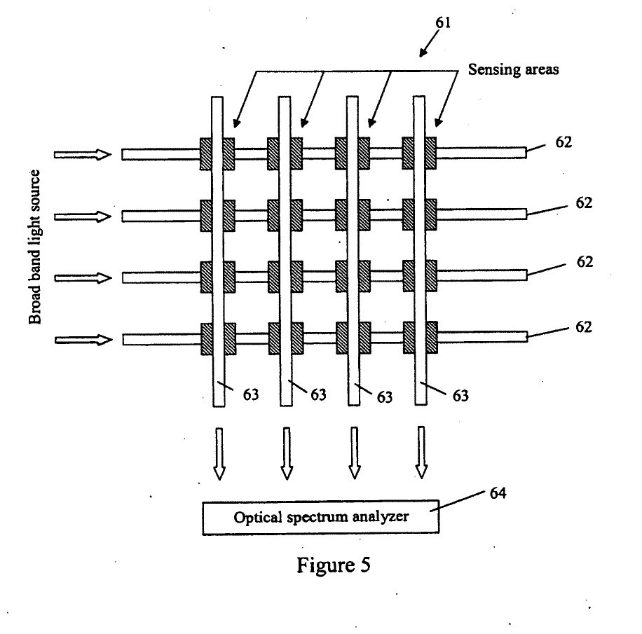

FIG. 5 shows an apparatus 61 for characterising a dielectric material in accordance with a further specific embodiment of the present invention. The apparatus 61 comprises in this example 4 waveguides 62 which are arranged for guiding light from a broad band light source. The 4 waveguides 62 cross 4 waveguides 63. At the crossings between the waveguides 62 and 63 sensors are positioned, each sensor comprising an Ag film functioning in the above described manner. In this embodiment the apparatus 61 comprises an array of 16 sensors and consequently is arranged so that a spatial distribution of a property associated with a dielectric material can be detected. When the apparatus 61 is exposed to the dielectric material, light emitted from the interfaces between the sensors and the dielectric material is coupled into the waveguides 63 so that each waveguide 63 guides light from 4 sensors in a multiplexed manner. An optical spectrum analyser 64 is then used for analysing the light. A person skilled in the art will appreciate that numerous variations of the described apparatus 61 are within the concept of the present invention.

What follows is an example of a method used to detect a dielectric material using sensors of different film thicknesses, with a specific comparison between an embodiment of the present invention that detects a dielectric material by collecting light from the surface of the sensor and a method that characterises the dielectric material by analysing light transmitted through the sensor.

Stripped sections of different optical fibre samples were immersed in a beaker containing an Ag coating solution (prepared as described previously) for different periods of time in order to form sensors 22, each having a different film thickness so as to evaluate the effect of the deposited Ag film thickness on the performance of each sensor 22. After coating, the fibres were rinsed in de-ionized water and then air dried and the thickness of the deposited silver coating was measured by scanning electron microscopy for each sample.

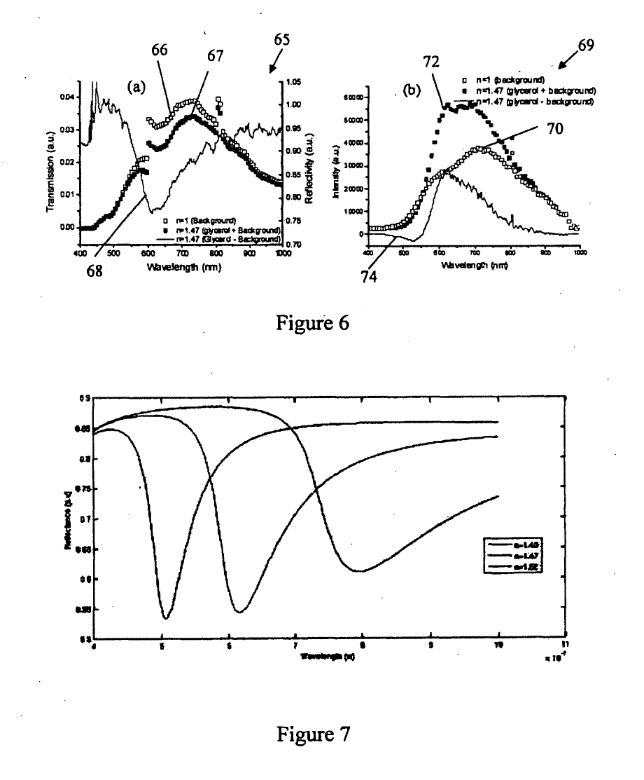

Graph 65 of FIG. 6(a) shows transmission measurements and graph 68 of FIG. 6(b) shows light collected from a transversal direction and the Ag film prior to and after the immersion of the sensing region into pure glycerol solution (n=1.47) for a 65 nm thick Ag coating.

Referring to the transmission measurements of graph 65 first, line 66 represents reference measurements taken before immersion into the glycerol solution and these measurements are used as a reference spectrum, line 67 represents sample measurements taken after immersion into the glycerol solution, and line 68 represents results wherein the reference measurements are subtracted from the sample measurements. A dip in the sample transmission measurements, indicated by line 67, can be observed around λ=636 nm of FIG. 6(a).

The transmission results described above fit the numerical simulations performed using the same physical parameters which are shown in FIG. 7, which shows a decrease of the reflectivity at 610 nm when the sensing region consisting of a 60 nm thick silver film deposited on a 4 mm section of a 140 μm diameter F2 (n=1.62) with the remaining of the fibre coated with a polymer cladding (n=1.52).

The slight wavelength shift between the transmission measurements of FIG. 6(a) and the theoretical measurements of FIG. 7 may be attributed to either coupling conditions of the incoming white light source into the fibre which will eventually change the power distribution inside the fibre and consequently the coupling condition of the guided light into the surface plasmons, or temperature variations that may have occurred during the experiment and which may be responsible for slight variations of the refractive index.

Referring now to the evanescent field measurements of graph 69, line 70 represents reference measurements taken before immersion into the glycerol solution and these measurements are used as a reference spectrum, line 72 represents sample measurements taken after immersion into the glycerol solution, and line 74 represents results wherein the reference measurements are subtracted from the sample measurements. An additional emission peak is featured in the spectrum associated with light from a side portion of the sensor (“evanescent field”) of FIG. 6(b). After background subtraction (line 74), this additional peak is shown to have a centre position (λ=647 nm) matching the position of the surface plasmon resonance signal measured in the transmission measurements of FIG. 6(a).

Transmission and evanescent field characterisation of fibres prepared with the same coating techniques but with different silver coating thickness are shown in FIGS. 6 to 11.

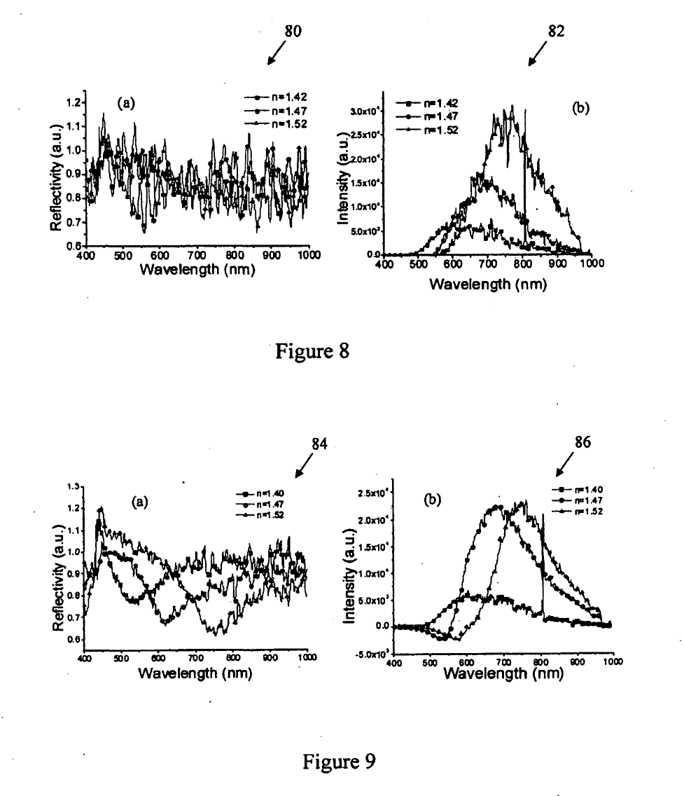

FIG. 8 shows graph 80 of transmission measurements taken of different solutions having a refractive index of n=1.42, 1.47 and 1.52 with a sensor having a silver film thickness of 21 nm, and graph 82 of evanescent field measurements taken of different solutions having a refractive index of n=1.42, 1.47 and 1.52 with a sensor having a silver film thickness of 21 nm.

FIG. 9 shows graph 84 of transmission measurements taken of different solutions having a refractive index of n=1.42, 1.47 and 1.52 with a sensor having an Ag film thickness of 40 nm, and graph 86 of evanescent field measurements taken of different solutions having a refractive index of n=1.42, 1.47 and 1.52 with a sensor having an Ag film thickness of 40 nm.

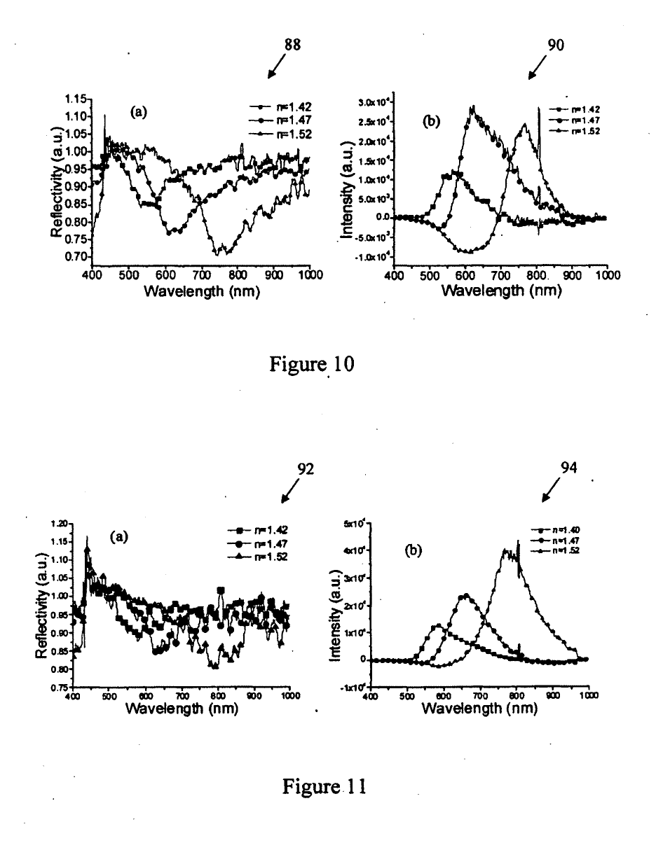

FIG. 10 shows graph 88 of transmission measurements taken of different solutions having a refractive index of n=1.42, 1.47 and 1.52 with a sensor having an Ag film thickness of 55 nm, and graph 90 of evanescent field measurements taken of different solutions having a refractive index of n=1.42, 1.47 and 1.52 with a sensor having an Ag film thickness of 55 nm.

FIG. 11 shows graph 92 of transmission measurements taken of different solutions having a refractive index of n=1.42, 1.47 and 1.52 with a sensor having an Ag film thickness of 65 nm, and graph 94 of evanescent field measurements taken of different solutions having a refractive index of n=1.42, 1.47 and 1.52 with a sensor having an Ag film thickness of 65 nm.

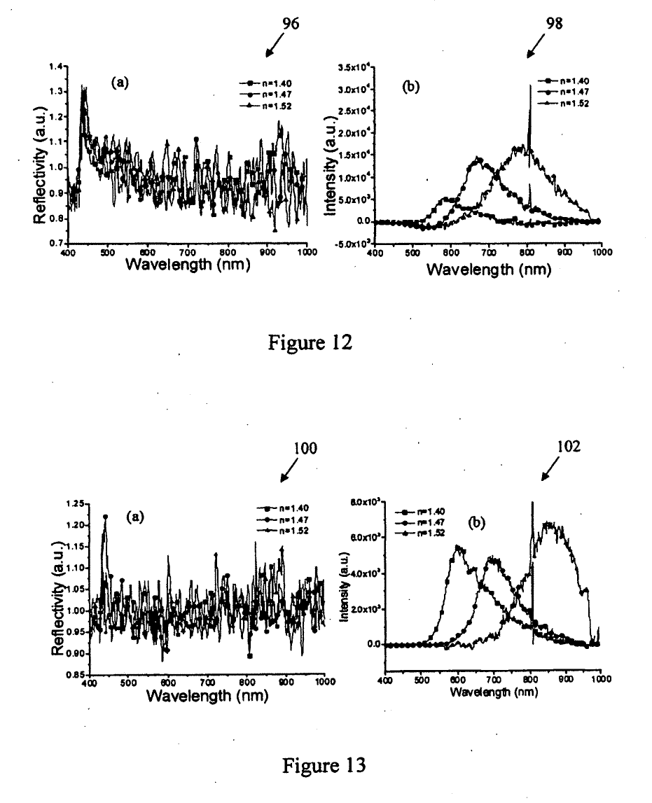

FIG. 12 shows graph 96 of transmission measurements taken of different solutions having a refractive index of n=1.42, 1.47 and 1.52 with a sensor having an Ag film thickness of 82 nm, and graph 98 of evanescent field measurements taken of different solutions having a refractive index of n=1.42, 1.47 and 1.52 with a sensor having an Ag film thickness of 82 nm.

FIG. 13 shows graph 100 of transmission measurements taken of different solutions having a refractive index of n=1.42, 1.47 and 1.52 with a sensor having an Ag film thickness of 132 nm, and graph 102 of evanescent field measurements taken of different solutions having a refractive index of n=1.42, 1.47 and 1.52 with a sensor having an Ag film thickness of 132 nm.

These figures show that the Ag coating thickness required to observe a surface plasmon resonance signal in transmission measurements is restricted to a relatively short range of thickness (from 40 to 65 nm) and the evanescent field measurements provides a surface plasmon resonance signal for a much range of Ag thicknesses.

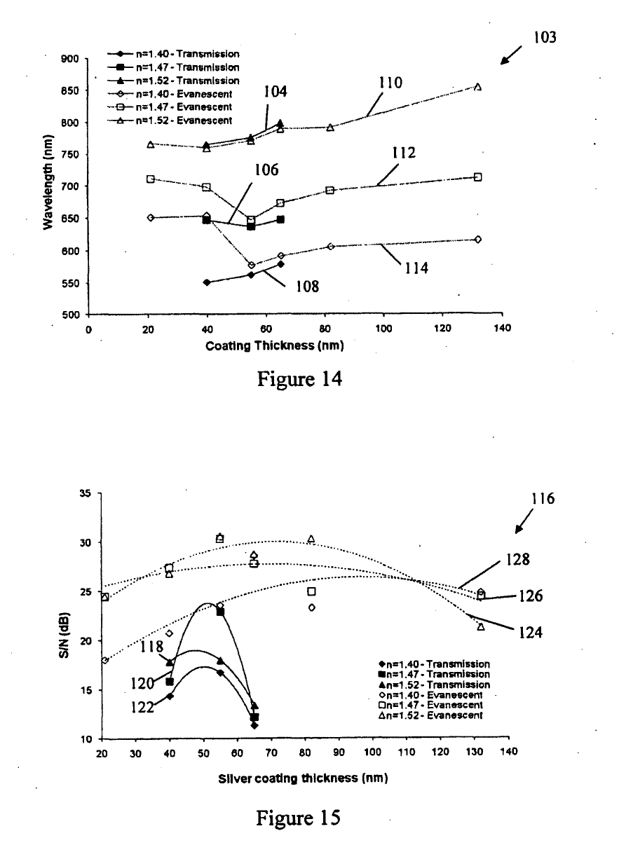

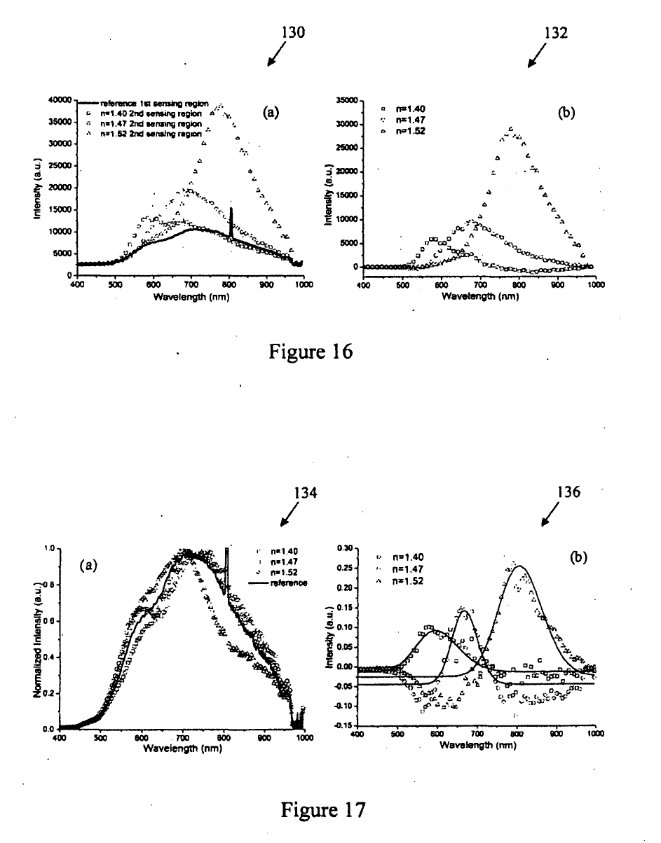

FIG. 14 shows a graph 103 of the position of the spectral surface plasmon resonance signal as a function of the deposited Ag thickness for different refractive index for the transmission measurements (lines 104, 106, 108) and evanescent field measurements (lines 110, 112, 114). It can be seen that the surface plasmon resonance position is in the same range for both techniques although for very thin coating, the evanescent field measurement differs from the transmission measurement for the reasons mentioned previously. The sensitivity of each fibre sample for both characterisation techniques has been calculated using Equation 4.

$$S = \frac{\partial λ}{\partial n} \qquad ( 4 )$$

The sensitivity, ˜5.7×10⁻⁴ RIU in transmission and ˜6×10⁻⁴ RIU for the evanescent field capture mode, are similar for both detection techniques apart for the thinner Ag coating, and in agreement with surface plasmon resonance sensitivity reported in the literature (10⁻⁵ to 10⁻⁸ RIU). However, the detection limit is a more reliable parameter for the description of a sensor's performance. In that context, the detection limit (DL) is defined as the ration between the resolution (R) of the sensor and its sensitivity (S). The resolution is itself defined as 3σ where σ as the average noise contribution from the signal amplitude (σ_{Ampl}), the spectral position (σ_{Spectral}) and the thermal noise (σ_{Therm}).

3σ=3\sqrt{σ_{Ampl}²+σ_{Spectral}²+σ_{Therm}²} (5)

The noise on the signal amplitude σ_{Ampl} is defined by Equation 6, where SNR is the signal to noise ratio and Δλ the wavelength shift of the surface Plasmon resonance.

$${σ}_{Ampl} = \frac{Δλ}{4.5 {( SNR )}^{025}} \qquad ( 6 )$$

In our case, the SNR was defined as

$$SNR = 20 \times log ( \frac{Signal Amplitude}{Noise Amplitude} ) ,$$

where the noise amplitude is defined as the standard deviation of the experimental data from a log normal fitting model defined by the equation 7 and the amplitude is simply the maximum or minimum on each spectrum depending on the acquisition method.

$$y = {y}_{0} + \frac{A}{\sqrt{2 π} wx} {e}^{- \frac{{ln ( \frac{x}{{x}_{c}} )}^{2}}{2 {w}^{2}}} \qquad ( 7 )$$

This fitting model was chosen instead of a Lorentzian as the experimental data present a characteristic asymmetry which was well fitted by Equation 7. The different parameters (y₀, A, x_{c} and w) where obtained using a standard fitting routine. The SNR such as that defined above is represented as a function of the deposited Ag thickness for different refractive index liquid measured both in transmission and using the evanescent field capture approach, in FIG. 15. FIG. 15 shows a graph 116 of the SNR of transmission measurements of a plurality of solutions having different refractive indices (lines 118, 120, 122) and the SNR of evanescent field measurements of a plurality of solutions having different refractive indices (lines 124, 126, 128).

From a rapid observation of FIG. 15, it appears that the SNR is always 10 dB higher when the surface plasmon resonance is characterized using the evanescent field capture approach, compared to the transmission measurements. For a rapid calculation of the other terms of the resolution, σ_{Therm} was assumed to be depending on the change of refractive index of the glycerol as function of the temperature. As a first approximation, a variation of +/−1° C. of the glycerol during the experimentation was taken into account which lead to a fluctuation of +/−0.002 RIU which corresponds to a σ_{Therm} ranging between 0.42 and 0.82 nm depending on the sensitivity. σ_{Spectral} was approximated by the error on the resonance position given by the fitting routine. The calculated values of the detection limit for each detection methods are summarized in Table 1.

In contrast to conventional transmission methods, the above described evanescent field method works for Ag coating thicknesses below approximately 40 nm or film thicknesses of the order of 40 nm both detection methods yield the same detection limit, whereas for higher Ag thickness, the detection limit of the evanescent field method is two times lower than that for the transmission measurements.

Further tests show that embodiments of the present invention may not be dependent on the manner in which the film 26 is formed. In particular, an alternative coating method was used, in this case thermal evaporation, for Ag deposition. Thermal evaporation has been reported in the literature for surface plasmon sensor fabrication, especially on optical fibre substrates. This method requires a rotational stage to be installed inside an evaporator in order to homogenously coat the entire fibre circumference.

TABLE 1

| | | Evanescent | | Detection |
|---|---|---|---|---|
| film | Transmission | field | Detection | Limit |
| coating | sensitivity | sensitivity | Limit | Evanescent |
| thickness | RIU/nm | RIU/nm | Transmission | field |
| 22 nm | NA | 1.03 × 10⁻³ | NA | 2.17 × 10⁻³ |
| | | | | RIU |
| 40 nm | 5.74 × 10⁻⁴ | 1.18 × 10⁻³ | 2.38 × 10⁻³ RIU | 2.38 × 10⁻³ |
| | | | | RIU |
| 55 nm | 6.49 × 10⁻⁴ | 6.99 × 10⁻⁴ | 2.60 × 10⁻³ RIU | 1.76 × 10⁻³ |
| | | | | RIU |
| 65 nm | 6.74 × 10⁻⁴ | 6.43 × 10⁻⁴ | 2.68 × 10⁻³ RIU | 1.70 × 10⁻³ |
| | | | | RIU |
| 82 nm | NA | 6.53 × 10⁻⁴ | NA | 1.71 × 10⁻³ |
| | | | | RIU |
| 132 nm | NA | 5.35 × 10⁻⁴ | NA | 1.60 × 10⁻³ |
| | | | | RIU |

In this example, only half of the surface of the exposed core region of the optical fibre was coated with different thicknesses of Ag. Similar measurements were performed and the same phenomena was observed, hence the evanescent field was enhanced at a spectral position depending on the refractive index liquid into which the fibre sensing region was immersed, corresponding to a surface plasmon resonance signal.

The above results show that using a spectral characterisation of the evanescent field around a section of an optical fibre coated with Ag can provide the same information than the traditional transmission measurements. However, this evanescent field collection mode yields higher signals to noise ratios which implies higher detection limit than its transmission counterpart. Moreover, this technique is less restrictive as a strict control on the thickness of the deposited Ag is no longer required.

The following example outlines test measurements done in respect of the apparatus of FIG. 3 that comprises first and second sensors 44, 46 wherein at least one of the sensors 44, 46 is used to take reference measurements. In the first series of measurements, results of which are shown in FIG. 17, the first sensor 44 was left exposed to air while the second sensor 46 was subjected to different refractive solutions. Graph 130 of FIG. 17 shows the results of these. It was found that the signal obtained from the first sensor 44 was constant and not depending on the refractive index seen in the second sensing region. Therefore, it was assumed that measurements taken in respect of the first sensor 44 can be used as reference measurements for the data analysis of measurements taken in respect of the second sensor 46. The spectra obtained from the second sensing region for different refractive indices after the subtraction of the reference signal are represented in graph 132 of FIG. 17 (b). Following data analysis, results obtained from measurements taken in respect of the second sensor 44 and using measurements taken in respect of the first sensor 46 as a reference were in good agreement with the previous results presented respect of FIG. 6. For further details, the results of the data analysis are summarised the Table 2 below.

TABLE 2

| Re- | surface | | | Average |
|---|---|---|---|---|
| fractive | plsamon peak | | Average | Detection |
| index | position | SNR | Sensitivity | Limit |
| 1.4 | 599.3 ± 0.6 nm | 22.84 dB | 6.11 × 10⁻⁴ RIU/nm | 1.61 × 10⁻³ |
| 1.47 | 696.8 ± 0.6 nm | 25.65 dB | | RIU |
| 1.52 | 796.0 ± 0.6 nm | 35.44 dB | | |

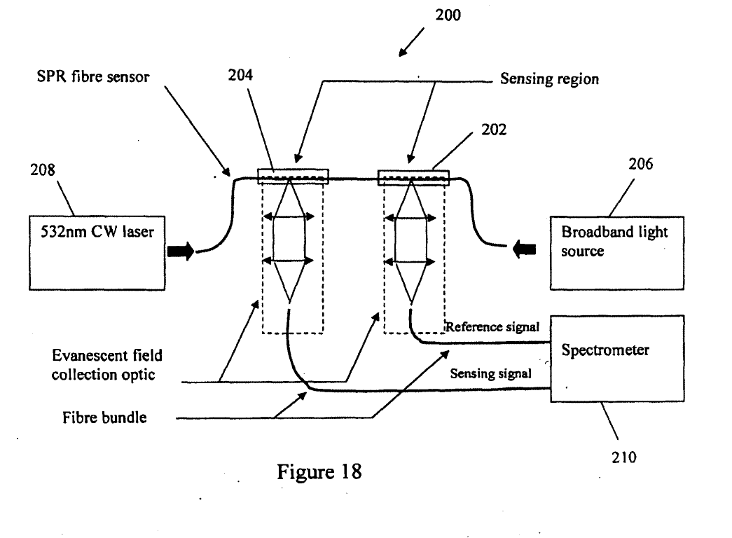

Similar experiments were conducted where the second sensor 46 was kept in air while the first sensor 44 was immersed in different refractive index liquids. Light from the surface of each sensor 44, 46 were measured. Graph 134 of FIG. 18 shows the reference spectrum measured using the second sensor 46, and the spectra measured by the first sensor 44 when immersed in solutions having different refractive indices.

Referring now to FIGS. 18 to 22 applications and an apparatus in accordance with further specific embodiments of the present invention are now described.

FIG. 18 illustrates an apparatus 200 that is similar to the apparatus 40 shown in FIG. 3 and comprises two of the apparatus 20 shown in FIG. 2. A first apparatus 202 of the type shown in FIG. 2 was positioned in a first flow cell (not shown) that was filled with a PBS buffer (Phosphate buffered saline). A second apparatus 204 of the type shown in FIG. 2 was positioned in a second flow cell (also not shown) that was filled with a PBS (Phosphate Buffered Saline) buffer and was used for the detection of a swine flu virus. The apparatus 200 further comprises a broadband light source 206 for providing light having a wavelength suitable for generating surface plasmons and a CW laser (532 nm) 208 generating light that is in use absorbed by label molecules (in this example Qdots), which in turn emit fluorescence radiation. Further, the apparatus 200 comprises a spectrometer 210 which is arranged to detect both an intensity of light indicative of the generated surface plasmons and the fluorescent radiation emitted form the Qdots.

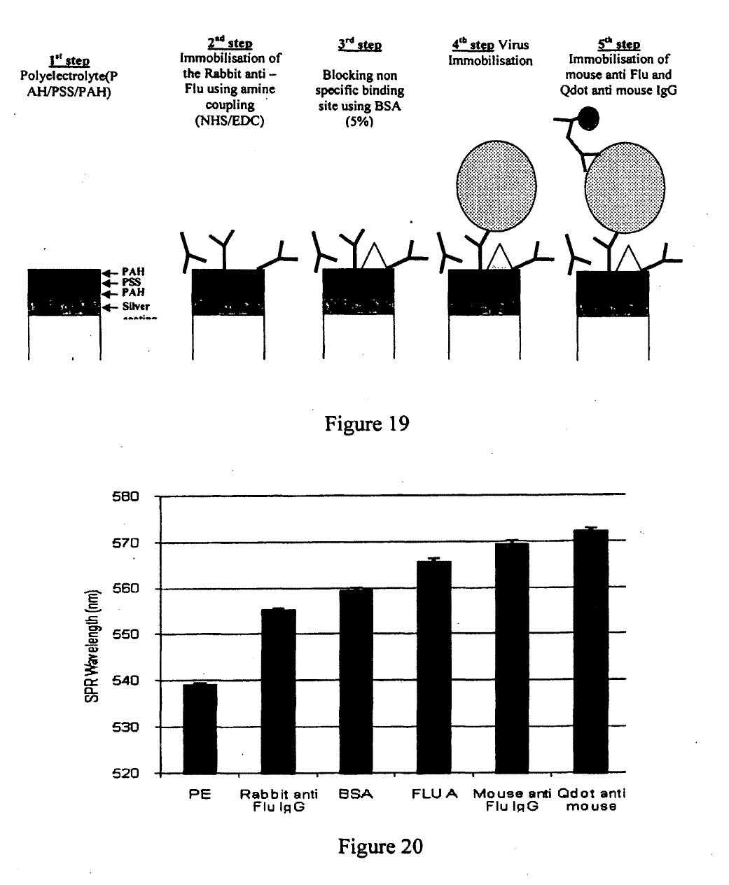

Surface functionalisition of the sensor will now be described with reference to FIG. 19. Initially a polyelectrolyte coating, comprising a PAH (PolyAllylamine Hydrochloride) layer followed by a PSS layer and then another PAH layer was applied to the Ag coating (1^{st} step) using the layer by layer deposition technique, providing amine functional groups on the coating surface, then an Rabbit anti-flu antibody was immobilised onto the surface using amine coupling reagents EDC/NHS (EDC: 1-Ethyl-3-[3-dimethylaminopropyl]carbodiimide hydrochloride; NHS: N-hydroxysuccinimide)(2^{nd} step). Non-specific binding states were blocked using BSA (Bovine Serum Albumin)(5%) (3^{rd} step), a swine flu virus was then immobilized (4^{th} step), specifically interacting with the rabbit anti-flu antibody and subsequently a mouse anti flu antibody followed by a Qdot labelled anti mouse antibody were immobilized (5^{th} step) in order to finalise a sandwich assay and confirm the presence of the swine flu virus onto the surface. The sensor was rinsed between each step using PBS buffer at pH 7.4.

After each of the above-described steps, plasmons were generated at the interface and light from the interface was collected in the previously described manner. The first flow cell provided reference data. FIG. 20 shows a table listing detected surface Plasmon wavelengths corresponding to the respective steps, which highlights the sensitivity of the method in accordance with embodiments of the present invention.

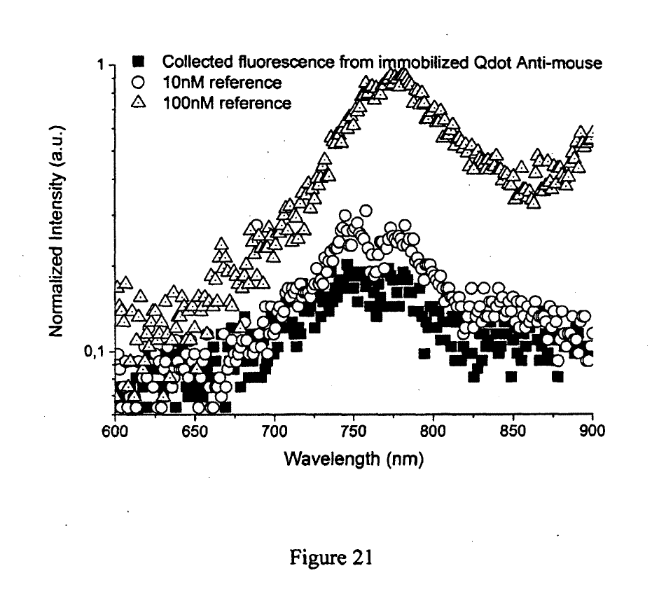

FIG. 21 shows the fluorescence spectra associated with the immobilised Qdot anti mouse collected in the same manner as the light indicative of generated surface plasmons. The spectra were recorded by detecting fluorescence radiation from immobilized Qdot label antibody after completion of the sandwich assay (filled symbols) and with a flow cell filled with known concentration of unbound quantum dot label antibody (10 nM and 100 nM). It is possible to provide independent confirmation of the diagnostic by recording the fluorescence emission form the Qdots, which also increases the specificity with which the virus (or other biological species) can be detected since it cascades 2 specific binding steps.

FIG. 21 shows that the spectral distribution of fluorescence radiation of the immobilized labelled antibodies is equivalent to that of the fluorescence radiation collected from a 1 nM solution of the fluorophore. The equivalence of this curve confirms that in the case of the bound, labelled, antibodies, the fluorescence of the Qdots is being detected along with the SPR-related emission.

The apparatus 200 also allows the use of a different sensing strategy that is especially useful for multiplexing. For example, different fluorescent labels, emitting at different wavelengths, can be used in order not only to detect influenza, as demonstrated in this example, but also to identify a viral strain assuming that specific secondary antibodies are available.

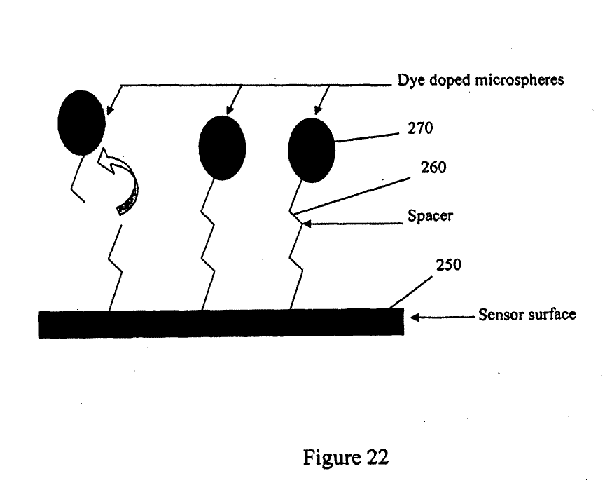

FIG. 22 shows a schematic representation of another specific embodiment of the present invention. FIG. 22 shows a sensor surface 250, which is the sensor surface of apparatus 204 shown in FIG. 18. Attached to the surface 250 are spacer molecules 260 that are suitable for adsorption to the surface 250 and are arranged for coupling to further molecules, such as molecules 270 that function as fluorescent labels and locally increase the refractive index at the surface, which results in change in intensity indicative of generated surface plasmons. In this example, the further molecules 270 are dye doped microspheres.

The spacer molecules 260 are arranged for cleaving by a predetermined type of molecule, such as a biological species. Cleaving the spacer molecules results in release of the microspheres, which induces a wavelength shift toward shorter wavelengths of the intensity indicative of surface plasmon generation and a corresponding reduction of the fluorescence intensity. Consequently, the predetermined type of molecule is detectable by measuring correlated spectral changes in intensities indicative of generation of surface plasmons and changes in fluorescence intensity.

The above-described concept can be generalised for multiplexed sensing assuming that different spacer molecules, which react specifically with different chemicals or biological species, are attached at one end to the surface of the interface and at the other end to microspheres containing different fluorescent dyes.

The method may also comprise re-attaching cleaved portions to respective cleaved spacer molecules at the interface such that the spacer molecules are again arranged for coupling to the spacer molecules. In one specific embodiment an antibody or the like may be attached to the loose end of a spacer molecule instead of a label molecule such as a Qdot. After an interaction between the antibody and its antigen counterpart, the spacer molecule may be cleaved by an enzyme and then regenerated by re-attaching the missing part of the spacer molecule such that the sensor can be re-used.

In addition, embodiments of the present invention provide information concerning a preferred orientation of the biological species at the interface. Second Harmonic Generation (SHG) associated with surface plasmon excitations at the interface is used for this purpose suitable laser light is directed to the interface. The laser light has a frequency that corresponds to a fundamental resonance frequency of the plasmonic excitation. In this process, the efficiency of generation of the second harmonic depends on the orientation of the biological species that are localised at the interface. For example, if the biological species are randomly oriented, an intensity of a signal associated with the SHG will be relatively low. Alternatively, if the biological species have a preferred orientation, the signal associated with the SHG is relatively large. Consequently, SHG can be used to probe the orientation of the biological species at the interface.

In the example described in the following the surface of a SPR fibre sensor, embedded into a microfluidic flow cell, was prepared for the specific detection of an enzyme (trypsine) using the cleaving of a specifically engineered spacer as transducing mechanism. The sensor was first coated with polyelectrolyte such as described previously (5 layers: PAH/PSS/PAH/PSS/PAH). The spacer itself is a long peptide chain with a carboxylic function on one end and an amine function on the other end, while the mid section of the spacer presents a chemical function that is design to be specifically cleaved by the enzyme.

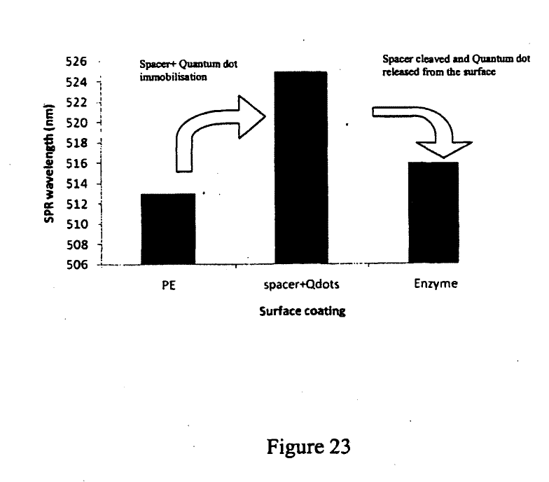

Therefore, the spacer was attached to the last PAH layer using amine coupling reagents (EDC/NHS), promoting the reaction between the amine function of the PAH layer and the carboxylic function of the spacer. Following the immobilisation of the spacer, large particles, in this case quantum dots surface functionalised with carboxylic function were attached to the free end of the spacer which presents an amine function, again using amine coupling reagent. At this stage, the sensor is ready to detect specifically the enzyme design to cleave the spacer and release the quantum dots and no blocking reagent are required since the detection is performed through the release of the quantum dots rather than the standard immobilisation onto the sensor surface. The spectral position of the surface plasmon resonance was monitored throughout the different steps of the surface functionalisation process. Following the injection of the enzyme into the flow cell, the wavelength shift of the surface Plasmon resonance was observed toward shorter wavelengths indicating the release of the quantum dots from the surface as shown in the FIG. 23.

Although the invention has been described with reference to particular examples, it will be appreciated by those skilled in the art that the invention may be embodied in many other forms.

1-20. (canceled)

21. A method of characterising a dielectric material, the method comprising the steps of:
providing a light source, a light collector and a sensor, the sensor being arranged so that an evanescent field of light penetrates a surface of the sensor and surface plasmons are generated at the surface of the sensor when suitable light is directed along at least a portion of the sensor;
exposing the surface of the sensor to the dielectric material so that an interface is formed between the surface and the dielectric material;
guiding light along at least a portion of the sensor to generate the surface plasmons; and
collecting an intensity of light from the interface as a function of a spectral parameter of the light.

22. The method of claim 21 wherein characterising the dielectric material comprises collecting an intensity of light from the interface with a sample dielectric material and from an interface with a reference dielectric material.

23. The method of claim 22 wherein the dielectric material is provided in the form of a biological suspension of a sample and the reference dielectric material comprises only the type of liquid that suspends the sample.

24. The method of claim 21 wherein the method comprises providing at least two sensors.

25. The method of claim 21 wherein the sensor comprises an optical waveguide and wherein a film formed from a material suitable for generation of surface plasmons is positioned at a surface of the optical waveguide and wherein the surface of the sensor is the surface of the film.

26. The method of claim 21 wherein the step of guiding light along at least a portion of the sensor comprises guiding light through the first optical waveguide and wherein the step of collecting an intensity of light from the interface comprises coupling the intensity of light from the interface into a second optical waveguide and wherein a film formed from a material suitable for generation of surface plasmons is positioned at a surface of a first optical waveguide.

27. The method of claim 21 wherein the step of guiding light along at least a portion of the sensor to generate the surface plasmons comprises absorbing light from the light source and emitting suitable fluorescence light to generate the surface plasmons.

28. The method of claim 21 wherein the step of exposing the surface of the sensor to the dielectric material comprises functionalising the surface and thereby providing a surface specificity such that predominantly a predetermined biological species adsorbs at the surface when the surface is exposed to a suitable dielectric material.

29. The method of claim 21 wherein the step of exposing the surface of the sensor to the dielectric material comprises coating the surface with a coating material that is selected so that the dielectric material will remove molecules of the coating material from the surface when the surface is exposed to the dielectric material.

30. An apparatus for characterising a dielectric material, the apparatus comprising:
at least one sensor having a sensing region and an optical waveguide for guiding light along the sensing region, the sensing region comprising a film having a structured surface for forming an interface with the dielectric material, the sensor being arranged such that the evanescent field of the light penetrates through at least a portion of the interface such that surface plasmons are generated at that interface when suitable light is directed though or adjacent the sensing region;
a light source; and
at least one collector for collecting an intensity of light from the interface as a function a spectral parameter of the light.

31. The apparatus of claim 30 wherein the sensor is one of at least two sensors and the collector comprises at least two collector elements for receiving light from respective sensors and wherein the at least two sensors comprise respective portions of the optical waveguide and are positioned in sequence along that optical waveguide.

32. The apparatus of claim 30 comprising a fluorescent material for absorption of light from the light source and emission of fluorescence radiation wherein the fluorescent material is arranged such that at least a portion of emitted fluorescence light is used for generation of surface plasmons.

33. The apparatus of claim 32 wherein the fluorescent material is selected to supplement a light intensity and/or a wavelength range of light emitted by the light source.

34. A method of characterising a dielectric material, the dielectric material, the method comprising the steps of:
generating surface plasmons by an evanescent field of light that penetrates an interface formed between a surface of a sensor and the dielectric material;
collecting a first intensity of light as a function of a spectral parameter of the light, the first intensity of light being indicative of an intensity of the generated surface plasmons; and
collecting a second intensity of light as a function of a spectral parameter of the light, the second intensity of light being indicative of a property of the dielectric material.

35. The method of claim 34 wherein the second intensity is associated with light emitted by label molecules and
wherein the steps of collecting the first and second intensities of light comprise collecting the first and second intensities of light from the interface.

36. The method of claim 35 wherein the label molecules emit fluorescence light having a spectral distribution that is indicative of immobilisation of a biological species with label molecules at the interface.

37. The method of claim 36 wherein the dielectric material comprises a biological suspension and the method comprises functionalising the surface at the interface thereby providing a surface specificity such that predominantly a predetermined biological species adsorbs at the surface and the label molecules adsorb at the biological species whereby both the first and second light intensities are indicative of immobilisation of the biological species at the interface.

38. The method of claim 34 wherein the second intensity of light relates to second harmonic generation (SHG) associated with a surface plasmon excitation at the interface.

39. The method of claim 34 comprising exposing the surface to spacer molecules that are arranged for adsorption at the surface of the interface and are also arranged for coupling to the label molecules and comprising detecting a spectral change in at least one of first intensity and the second intensity, which is indicative of cleaving of the spacer molecules and adsorption of a predetermine type of molecule at the cleaved spacer molecule on the surface of the interface.

40. An apparatus for characterising a dielectric material, the apparatus comprising:
at least one sensor having a sensing region and being arranged for directing suitable light though or adjacent the sensing region, the sensing region having a surface for forming an interface with the dielectric material, the sensor being arranged such that an evanescent field of the light penetrates through at least a portion of the interface whereby surface plasmons are generated at that interface;
a light source; and
at least one collector for collecting first and second intensities of light as a function of a spectral parameter of the light, the first intensity of light being indicative of an intensity of the generated surface plasmons and the second intensity of light being associated with a property or of the dielectric material.
